(19) United States
(12) Patent Application Publication
(10) Pub. No.: US 2026/0323794 A1
(43) Pub. Date: Oct. 15, 2026

(54) THIN, FLEXIBLE AND LUMINOUS ELECTROLUMINESCENT FILM

(71) Applicant: VALEO VISION, Bobigny (FR)

(72) Inventors: Eduardo ALVEAR, Bobigny (FR); Sidahmed BEDDAR, Bobigny (FR)

(73) Assignee: VALEO VISION, Bobigny (FR)

(21) Appl. No.: 19/483,644

(22) PCT Filed: May 8, 2024
(86) PCT No.: PCT/EP2024/062826

§ 371 Date: Nov. 12, 2025

(30) Foreign Application Priority Data
May 11, 2023 (FR) FR2304675
May 11, 2023 (FR) FR2304685

(51) Int. Cl. H05B 33/14; C09K 11/58; H01B 3/12; H01B 3/40; H05B 33/20; H05B 33/26

(52) U.S. Cl. CPC H05B 33/145; C09K 11/584; H01B 3/12; H01B 3/40; H05B 33/20; H05B 33/26

(57) ABSTRACT

The film (1) comprises, in succession:—a flexible support layer (2); —a first flexible electrode layer (3) made of conductive material; —a flexible electrically insulating layer (4) made of dielectric material; —a flexible electroluminescent layer (5) comprising a luminophore layer (6) having a refractive index nₗᵤₘ and at least one element (7) for adapting the refractive index having a refractive index n_{ng}; —a second flexible and transparent electrode layer (8) made of conductive material having a refractive index n_{elec}; —a flexible and transparent protective layer (9); —wherein nₗᵤₘ>n_{ng}>n_{elec}.

### TECHNICAL FIELD

The technical field of the invention is the field of electroluminescent films.

The present invention relates to an electroluminescent film, preferably transparent, which is both very flexible and very bright when supplied with alternating electric current.

### BACKGROUND OF THE INVENTION

As an alternative to LED arrays as a luminous surface, several electroluminescent films have recently been developed, in which a phosphor layer is excited by an electrostatic field. These electroluminescent films are thin and have a low electricity consumption, but above all they can be flexible and transparent.

Among these films, very bright transparent electroluminescent films are known, with a luminance of around 1300 cd/m², but with reduced flexibility because they include a glass substrate. In addition, the design of these films is only compatible with ZnS:Mn phosphors and therefore only makes it possible to emit a yellow or green color.

Other electroluminescent films are also known, which are flexible and the design of which makes it possible to emit any type of color. However, these films have only a low luminance, generally of less than 150 cd/m², and they are therefore much less bright than the above films.

However, there is a need for an electroluminescent film, preferably entirely transparent, which is both very flexible, for example so that it can be applied to recessed or raised surfaces, and very bright, in particular so as to contrast with the external ambient brightness. Such a film is particularly highly anticipated in the automotive field so that it can be used, for example, not only for luminous signalling outside vehicles, but also for decoration and display inside and outside vehicles. Such a film must advantageously make it possible to emit any type of color, and be easy and inexpensive to manufacture.

In the automotive field, certain luminous devices are provided to emit red light, in particular for rear brake lights, also referred to as stop lights. For many years, brake lights have had an incandescent bulb positioned behind a transparent red-tinted plastic.

There is thus a need for a luminous device that is thin, supple, flexible and energy-efficient, capable of covering concave and/or convex passenger compartment and bodywork parts, and that can emit red light having a wavelength corresponding to the standards in force as regards the red color authorized for brake lights.

### SUMMARY OF THE INVENTION

The invention offers a solution to the problems mentioned above by providing an electroluminescent film based on a top-emission architecture comprising a stack of layers emitting light from the top of the structure and in which at least one additional refractive index adaptation element is provided to direct light from the phosphor layer to the electrode layer above it.

One aspect of the invention relates to an electroluminescent film comprising successively:
a flexible support layer;
a first flexible electrode layer made of conductive material;
a flexible electrically insulating layer made of dielectric material;
a flexible electroluminescent layer, comprising a phosphor layer having a refractive index nₗᵤₘ and at least one refractive index adaptation element having a refractive index n_{ng};
a second flexible and transparent electrode layer made of conductive material having a refractive index n_{élec};
a flexible and transparent protective layer;
in which nₗᵤₘ>n_{ng}>n_{élec}.

The invention provides an electroluminescent film which is advantageously thin, lightweight, flexible, very bright and which can provide all the lighting colors of the visible spectrum.

Following numerous studies, the applicant notably found that the phosphor layer and the second electrode layer have refractive indices that are very different, and this results in refraction and/or reflection of the light emitted by the phosphor layer when it encounters the second electrode layer. Thus, in electroluminescent films based on a top-emission architecture comprising a stack of layers, the applicant found that this difference in the refractive indices of these two successive layers considerably reduces the overall luminance.

In order to improve the luminance of this type of film, the applicant sought a solution to these problems of refraction and reflection of the emitted light.

After extensive research, the applicant found that introducing an additional material having an intermediate refractive index with respect to those of the phosphor layer and the second electrode layer, and capable of directing light to a material having a lower refractive index, provides very satisfactory results.

To be specific, by virtue of this refractive index adaptation element, the overall luminance of the electroluminescent films is multiplied by 1.8, or even multiplied by 2. Thus, the electroluminescent film according to the invention, in addition to being very thin, lightweight and flexible, is also very bright.

According to one aspect of the invention, the phosphor layer comprises zinc sulfide doped with at least one metal including copper. This type of phosphor is advantageously known for its ability notably to emit any type of color, and for being easy and inexpensive to implement.

According to another aspect of the invention, the electroluminescent layer comprises a refractive index adaptation element layer located above the phosphor layer. Thus, the refractive index adaptation element is an intermediate layer between the electroluminescent layer and the second electrode layer in order to advantageously direct light from the phosphor layer to the layer above.

According to a further aspect of the invention, the electroluminescent layer comprises refractive index adaptation elements embedded in the phosphor layer. Thus, the electroluminescent layer is heterogeneous, with refractive index adaptation elements that advantageously direct light from the phosphors to the upper layer.

According to one aspect of the invention, a refractive index adaptation element comprises nanoantennas. Indeed, these nanoantennas advantageously direct light to the neighboring medium having the lowest refractive index, in this case the second electrode layer.

According to another aspect of the invention, the nanoantennas are colloidal nanoparticles, preferably nanocubes.

According to a further aspect of the invention, the nanoantennas are nanofibers, nanotubes, nanofilaments, nanowires or nanorods.

According to one aspect of the invention, the nanoantennas are based on silver, gold, platinum, zinc oxide or a mixture thereof.

To be specific, these nanoantennas make it possible to provide an advantageously transparent refractive index adaptation element, which can be deposited in an extremely thin layer and has a very good transmittance.

According to another aspect of the invention, the refractive index adaptation element layer has a thickness of less than 1 μm. To be specific, the nano-objects described above may be supplied with a very thin thickness, which allows the additional refractive index adaptation element layer to avoid reducing the flexibility, transparency and brightness of the electroluminescent film by very much.

According to a further aspect of the invention, the dielectric material of the electrically insulating layer comprises an epoxy resin matrix filled with alkaline-earth metal titanate particles selected from: CaTiO₃, BaₓSr₍₁₋ₓ₎TiO₃ and a mixture thereof, with 0≤x≤1.

While it is usually known that the layer of dielectric material must have a sufficient thickness to be insulating, the applicant has carried out numerous studies aimed at creating an electroluminescent film that is thin, lightweight and flexible. Therefore, against all expectations, it sought to reduce the thickness of the layer of dielectric material as much as possible, but without affecting its insulating character.

Thus, according to one aspect of the invention, the electrically insulating layer has a thickness comprised between 1 and 50 μm, preferably comprised between 5 and 30 μm, more preferably comprised between 8 and 15 μm and even more preferably equal to 10 μm.

To be specific, the applicant determined that a dielectric material comprising an epoxy resin matrix filled with alkaline-earth metal titanate particles selected from: CaTiO₃, BaₓSr₍₁₋ₓ₎TiO₃ and a mixture thereof allows electrostatic forces to be exerted while being an electrical insulator satisfactory for use in an electroluminescent film, even when it is supplied with a thickness comprised between 1 and 50 μm, which also allows it to be transparent. Thus, an electroluminescent film comprising such a layer of dielectric material may be transparent, is very thin, lightweight and flexible, and is advantageously very bright, with a luminance greater than 900 cd/m², even in the absence of a refractive index adaptation element.

According to another aspect of the invention, the support layer has a thickness comprised between 0.5 and 2.0 mm, preferably comprised between 0.8 and 1.5 mm and more preferably equal to 1.1 mm.

According to a further aspect of the invention, at least one layer out of the first and second electrode layers has a thickness comprised between 1 and 500 μm, preferably comprised between 10 and 50 μm, and more preferably equal to 25 μm.

According to one aspect of the invention, the phosphor layer has a thickness comprised between 1 and 50 μm, preferably comprised between 25 and 35 μm, and more preferably equal to 29 μm.

According to another aspect of the invention, the protective layer has a thickness comprised between 0.5 and 2.0 mm, preferably comprised between 0.8 and 1.5 mm and more preferably equal to 1.1 mm.

These ranges of thicknesses advantageously make it possible to have an electroluminescent film that is very thin and therefore both flexible and lightweight. Advantageously, its suppleness and flexibility make it possible in particular to use the film of the invention to cover very diverse parts having concave and/or convex, sometimes complex shapes. These ranges of thicknesses also make it possible to have an electroluminescent film that may be transparent.

According to a further aspect of the invention, at least one layer out of the first electrode layer and the second electrode layer is in the form of a nanomesh, an electrode mesh or a homogeneous planar layer.

Advantageously, providing an electrode layer in the form of a nanomesh or an electrode mesh makes it possible in particular to pass an electric current through almost the entire electrode layer, even if some wires break locally, for example as a result of excessive deformation of the film by bending.

Providing an electrode layer in the form of a homogeneous planar layer, forming a large surface area, is advantageous for reasons of cost and simplicity of depositing said layer, but such a film is liable to crack when it is handled, which then increases its resistivity. Advantageously, such electrode layers also make it possible to have an electroluminescent film that may be transparent.

According to one aspect of the invention, at least one layer out of the first electrode layer and the second electrode layer comprises nanowires of silver, copper, gallium nitride or zinc oxide, nanotubes of carbon, graphene, a material based on metal oxide, a material based on poly(3,4-ethylenedioxythiophene), a material based on poly(3,4-ethylenedioxythiophene) mixed with sodium polystyrene sulfonate or a material based on poly(3,4-ethylenedioxythiophene) mixed with tosylate.

According to another aspect of the invention, the material based on metal oxide comprises at least one compound selected from indium-tin oxide, zinc oxide, aluminum-doped zinc oxide, titanium dioxide and fluorine-doped tin dioxide.

These materials are excellent electrical conductors and may advantageously be provided in the form of very thin layers, allowing the film to have very satisfactory flexibility and transparency in particular.

According to a further aspect of the invention, the support layer, the first electrode layer, the electrically insulating layer and the electroluminescent layer are also transparent. Thus, all the layers are transparent, which advantageously makes it possible to provide a fully transparent electroluminescent film.

According to one aspect of the invention, at least one layer out of the support layer and the protective layer is made of polyethylene terephthalate, a siloxane based on polymerized silicon monoxide, polymethyl methacrylate, polycaprolactone, polycarbonate or a mixture of two or more of these products.

To be specific, these materials are transparent and may advantageously be supplied with very small thicknesses, while offering good adhesion with the adjacent layers. The use of thin layers makes it possible to produce films as lightweight as possible.

According to another aspect of the invention, the phosphor layer comprises zinc sulfide, a mixture of zinc sulfide and cadmium sulfide, or a mixture of zinc sulfide, cadmium sulfide, zinc selenide and cadmium selenide, these metal compositions being doped with copper alone or doped with copper and with at least one compound selected from the group consisting of yttrium aluminum garnet, manganese, aluminum, europium and inorganic dyes.

These phosphors are advantageously very bright and make it possible to provide all ranges of colors in the visible spectrum.

According to a further aspect of the invention, the phosphors are provided in the form of particles having a diameter less than or equal to 50 μm, preferably less than or equal to 35 μm and more preferably less than or equal to 29 μm, this advantageously makes it possible to provide a phosphor layer that is as thin as possible.

According to a further aspect of the invention, the protective layer comprises a transparent anti-UV material, an anti-UV additive or a transparent anti-UV coating. Thus, in addition to its role of protection from the surroundings, the protective layer also protects the film against the effects of ultraviolet radiation.

According to one aspect of the invention, the protective layer comprises a layer of transparent anti-UV material selected from an acrylic resin, a mixture of high-density polyethylene and zinc oxide, polycarbonate, polyamide-imide and poly(vinylidene fluoride).

These materials in fact afford very efficient anti-UV protection and may therefore be provided in a very thin layer contributing to the flexibility and transparency of the film.

According to one aspect of the invention, the overall thickness of the film is comprised between 1.0 and 5.0 mm, more preferably comprised between 1.5 and 3.5 mm and more preferably comprised between 2.0 and 2.5 mm.

According to another aspect of the invention, the film comprises successively:
a support layer made of PET;
a first electrode layer comprising an indium tin oxide nanomesh, silver nanowires or copper nanowires;
an electrically insulating layer comprising an epoxy resin matrix filled with barium titanate particles;
an electroluminescent layer, comprising a phosphor layer comprising zinc sulfide doped with at least one metal including copper, and comprising at least one refractive index adaptation element comprising zinc oxide nanowires or silver nanocubes;
a second electrode layer comprising an indium tin oxide nanomesh, silver nanowires or copper nanowires; and
a protective layer comprising Plasil.

One aspect of the invention also relates to a method for manufacturing a film as described above, comprising the following successive steps:
providing a flexible support layer;
depositing a first flexible electrode layer made of conductive material on the flexible support layer;
depositing a flexible electrically insulating layer made of dielectric material on the first electrode layer;
depositing a flexible electroluminescent layer on the electrically insulating layer, said electroluminescent layer comprising a phosphor layer having a refractive index nₗᵤₘ and at least one refractive index adaptation element having a refractive index n_{ng};
depositing a second flexible and transparent electrode layer made of conductive material on the nanoantenna layer, said second electrode layer having a refractive index n_{élec};
depositing a protective layer on the second electrode layer;
in which nₗᵤₘ>n_{ng}>n_{élec}.

This manufacturing method is advantageous in that it may be implemented in a simple and inexpensive way. It advantageously makes it possible to manufacture a film of large dimensions which can then be cut to the desired dimensions.

According to one aspect of the invention, the support layer is provided in the form of a roll of film, which is practical, inexpensive and easy to use for the manufacture of a film according to the invention.

According to another aspect of the invention, at least one layer out of the first electrode layer and the second electrode layer is deposited by bar coating, vapor phase polymerization, chemical vapor deposition, sputtering or dry deposition.

According to a further aspect of the invention, the electrically insulating layer is deposited by bar coating.

According to one aspect of the invention, the deposition of the electroluminescent layer comprises a step of depositing a flexible phosphor layer on the electrically insulating layer, then a step of depositing a refractive index adaptation element layer on said phosphor layer.

According to another aspect of the invention, the preceding phosphor layer is deposited by screen printing or by atomic layer deposition.

According to a further aspect of the invention, the deposition of the electroluminescent layer comprises a step of depositing refractive index adaptation elements on the electrically insulating layer, then a step of depositing a flexible phosphor layer at least between said refractive index adaptation elements.

According to one aspect of the invention, the preceding phosphor layer is deposited by a sol-gel process.

According to another aspect of the invention, at least one refractive index adaptation element is in the form of nanoantennas, and these nanoantennas are deposited by drop casting or by hydrothermal synthesis.

According to a further aspect of the invention, the protective layer is deposited by printing.

To be specific, the techniques mentioned above are adapted to the deposition of the constituent material of each layer and advantageously make it possible to deposit very thin and transparent layers in a reliable, controlled and homogeneous manner. Bar coating is also very cost effective and very easy to implement.

For the deposition of a phosphor layer, screen printing is also advantageous in that it makes it possible to deposit any type of phosphor on rigid or flexible supports, while atomic layer deposition advantageously makes it possible to deposit an extremely thin and transparent layer controlled at atomic level which offers excellent light extraction efficiency.

Another aspect of the invention relates to a flexible electroluminescent film comprising successively:
a flexible support layer;
a first flexible electrode layer made of conductive material;
a flexible electrically insulating layer made of dielectric material;
a flexible electroluminescent layer, comprising a phosphor layer having a refractive index nₗᵤₘ and emitting red light when excited by an electrostatic field;
a second flexible and transparent electrode layer made of conductive material having a refractive index n_{élec}; and
a flexible and transparent protective layer.

The invention provides an electroluminescent film which is advantageously thin, lightweight, flexible, very bright and which can provide red lighting. This film is very bright, allowing it to contrast with the ambient light and to meet the brightness standards in force for rear lights, while having a much lower power consumption than LEDs. It is also thin and flexible enough to be applied to complex concave and/or convex surfaces. Advantageously, the nature and the small thickness of each of the layers of the electroluminescent film notably allow it to be thin and flexible, but they may also allow it to be fully transparent.

According to another aspect of the invention, the phosphor layer comprises a mixture of particles of zinc sulfide, cadmium sulfide, zinc selenide and cadmium selenide, which particles are doped with copper. To be specific, this type of phosphor is advantageously very bright and can in particular provide red lighting.

According to a further aspect of the invention, the mixture has the following composition: (Znₓ,Cd₁₋ₓ)(S_{y},Se_{1-y}):Cu, with 0<x<1 and 0<y<1.

According to one aspect of the invention, 0.8<x<1 and 0<y<0.2.

According to another aspect of the invention, x=0.9 and y=0.1.

In fact, many studies and tests carried out by the applicant have established that these compositions make it possible to provide red lighting meeting the standards currently in force, in particular for stop lights. These compositions advantageously make it possible to provide a red color having a wavelength comprised between 625 and 635 nm, preferably substantially equal to 630 nm, and with a full width at half maximum of less than 20 nm.

According to a further aspect of the invention, the phosphor layer emits a red color having a wavelength comprised between 625 and 635 nm, preferably substantially equal to 630 nm, and with a full width at half maximum of less than 20 nm, which makes it possible to meet the standards currently in force with regard to the color emitted by stop lights.

Another aspect of the invention relates to a vehicle component, which is at least partially covered by a film as described above. Thus, this vehicle component, even in the case where it has complex concave and/or convex shapes, may advantageously be combined with a film according to the invention in order to emit intense red light. In the case where the film is advantageously transparent, its presence is therefore extremely discreet when it is not luminous, which represents a major esthetic advantage, especially in the automotive field, where manufacturers generally seek to conceal optics, which are considered unattractive.

According to one aspect of the invention, said vehicle component is a bodywork part, a dashboard, a decorative part, a grille, a logo or an optical element. The film according to the invention may in fact advantageously be used in a very wide range of applications, and not only in the automotive field.

A further aspect of the invention relates to a method for manufacturing a film as described above, which method comprises the following successive steps:
providing a flexible support layer;
depositing a first flexible electrode layer made of conductive material on the flexible support layer;
depositing a flexible electrically insulating layer made of dielectric material on the first electrode layer;
depositing a flexible electroluminescent layer on the electrically insulating layer, said electroluminescent layer comprising a phosphor layer emitting red light when excited by an electrostatic field;
depositing a second flexible and transparent electrode layer made of conductive material on the electroluminescent layer;
depositing a flexible and transparent protective layer on the second electrode layer.

### BRIEF DESCRIPTION OF THE DRAWINGS

The present invention will be understood more clearly and further features and advantages will emerge on reading the following detailed description comprising embodiments provided by way of illustration with reference to the accompanying figures, which are provided by way of non-limiting examples and which may be used to aid the understanding of the present invention and the disclosure of its implementation and, where applicable, contribute to its definition, in which figures:

FIG. 1 schematically depicts an example of an electroluminescent film according to a first variant of the invention, in which the electroluminescent layer comprises two successive layers.

FIG. 2 schematically depicts an example of an electroluminescent film according to a second variant of the invention, in which the electroluminescent layer comprises refractive index adaptation elements embedded in a phosphor layer.

FIG. 3 is a detailed view of the encircled part in FIG. 1.

FIG. 4 is a detailed view of the encircled part in FIG. 2.

FIG. 5 schematically depicts an example of an electrode layer comprising a nanomesh according to the invention.

FIG. 6 is a detailed view of the encircled part in FIG. 5.

FIG. 7 schematically depicts an example of square patterns for the mesh of a nanomesh according to the invention.

FIG. 8 schematically depicts an example of rectangular patterns for the mesh of a nanomesh according to the invention.

FIG. 9 schematically depicts an example of diamond patterns for the mesh of a nanomesh according to the invention.

FIG. 10 schematically depicts an example of hexagonal patterns for the mesh of a nanomesh according to the invention.

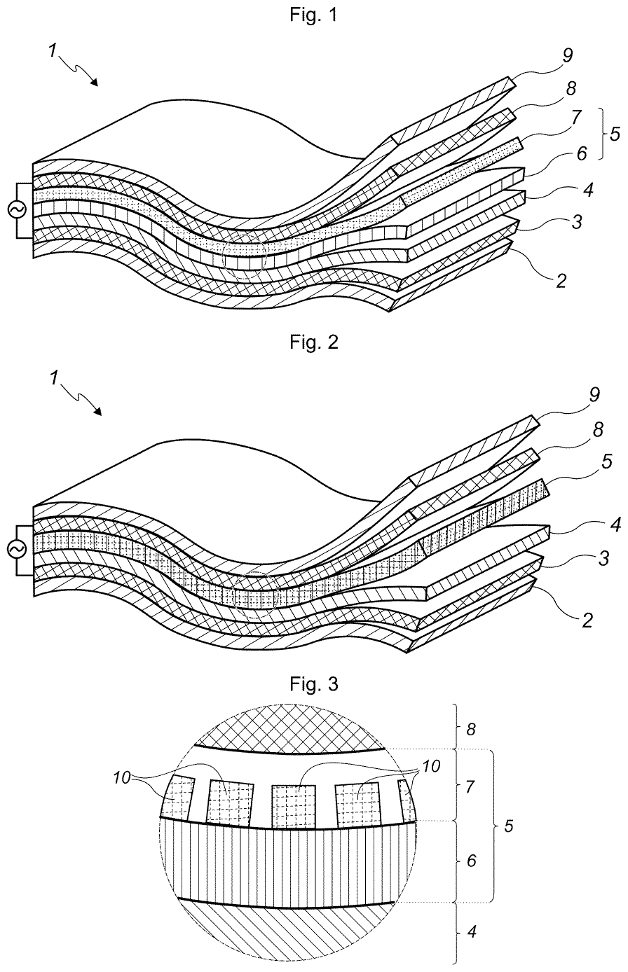

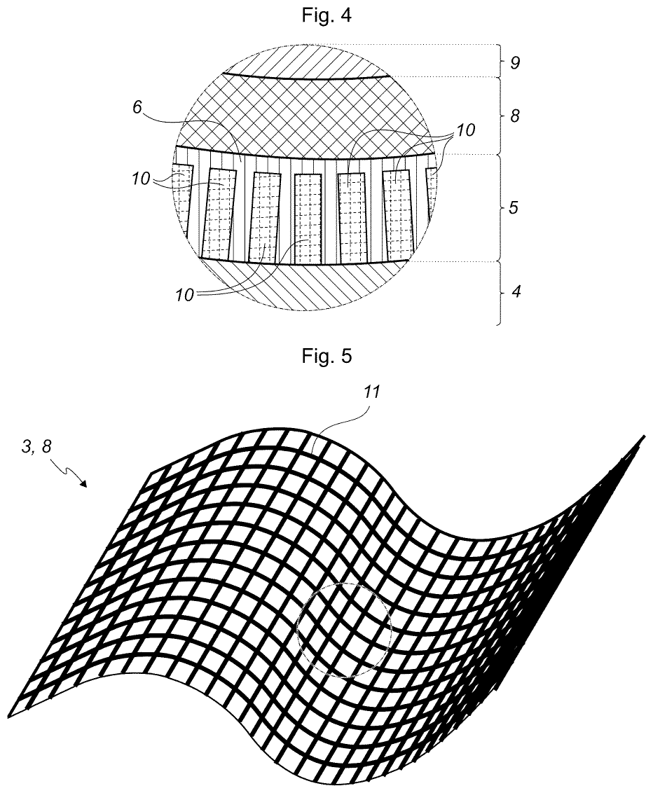

The thicknesses of the layers shown in FIG. 1, FIG. 2, FIG. 3 and FIG. 4 are given for illustrative purposes only and do not represent reality in any way.

### DETAILED DESCRIPTION OF THE INVENTION

Unless stated otherwise, the same element appearing in different figures is provided with a single reference.

By convention, in the present application, the terms “lower” and “upper”, and “inner” and “outer”, are defined with respect to the position of the electroluminescent film as shown in FIG. 1 and FIG. 2. Thus, an outer layer such as the protective layer is shown in the upper part of the film in FIG. 1 and FIG. 2 while an inner layer, such as the support layer, is shown in the lower part of the film, even though the film may be used in another orientation.

In the context of the invention, a material or a layer of material is said to be flexible if the mechanical and electrical properties of the film remain unchanged even under a high stress of 2.5% with a concave and convex radius of curvature of 0.5 mm. In other words, an electrode layer on the support layer may notably be considered flexible if, after a deformation of 2.5%, this deformation does not affect the variation in the electrical resistance of the electrode film deposited on the support layer. Deformation (flexibility) can be evaluated using the following equation:

Deformation=(ts−tp−tf)/2×rc, where:
ts is the thickness of the support layer;
tp is the total thickness of the working layers (luminescent layer+electrically insulating layers)
tf is the total thickness of the electrode layers
rc is the radius of curvature.

Lastly, the term “transparent” means an optically transparent material, i.e. having a transmittance greater than 75% in the visible spectrum.

The film 1 according to the invention is a flexible electroluminescent film 1 comprising at least six superimposed flexible layers, each layer being in contact with the adjacent layer(s), namely a support layer 2, a first electrode layer 3, an electrically insulating layer 4, an electroluminescent layer 5, a second electrode layer 8 and a protective layer 9.

The film 1 according to the invention comprises a first layer, preferably a lower layer, which is a flexible support layer 2, on which the other layers are deposited. This support layer 2 is preferably provided in the form of a roll of film. It has, for example, a thickness comprised between 0.5 and 2.0 mm, preferably comprised between 0.8 and 1.5 mm and more preferably equal to 1.1 mm.

The support layer 2 may be transparent, in particular when it is desired for the entire film 1 to be transparent. It may also be opaque, for example when the film 1 is intended to be applied to a surface which is also opaque.

In particular, in the case where this layer is transparent, the support layer 2 is preferably made of PET (polyethylene terephthalate), Plasil (siloxane based on polymerized silicon monoxide), PMMA (polymethyl methacrylate), PCL (polycaprolactone), PC (polycarbonate), COP (cyclic olefin polymer) or a mixture of at least two of these products.

The film 1 according to the invention comprises a second layer, deposited on the support layer 2, namely a first flexible electrode layer 3 made of conductive material.

This first electrode layer 3 is preferably provided in the form of a nanomesh 11, an electrode mesh or a homogeneous planar layer.

Nanomesh means a nanostructure in the form of a net, formed of nanowires in mutual contact and forming a mesh, whether these wires are, for example, interwoven, superimposed, welded or in a single piece. A nanowire is a nanostructure in the form of a wire, with a diameter on a nanometric scale, for example less than 100 nm, and a length which is significantly longer.

Electrode mesh means a structure in the form of a net, formed of wires that are interwoven, superimposed, welded or in a single piece, these wires having a diameter of the order of a micron.

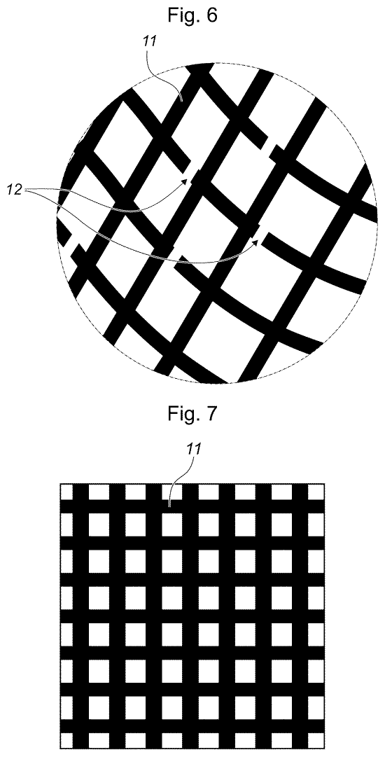

An example of a nanomesh 11 is shown in FIG. 5, this figure being equally suitable for illustrating an electrode mesh.

When a nanomesh 11 or electrode mesh is bent, rupture zones 12 may appear in the mesh of such a structure. As shown in FIG. 6, such rupture zones 12 do not prevent the flow of current throughout the mesh as the current can flow through intact wires located nearby, and this enables the film 1 to remain functional and to retain its optimum brightness even after very considerable bending of the nanomesh 11 or electrode mesh.

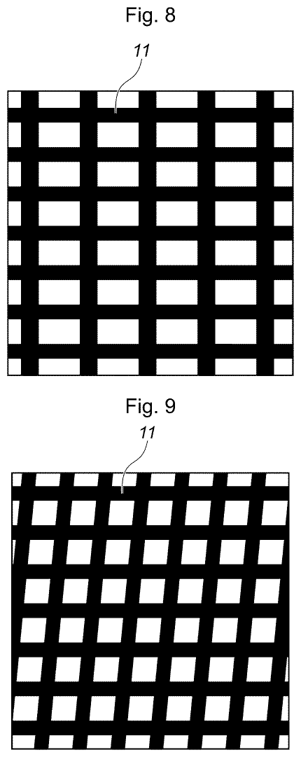

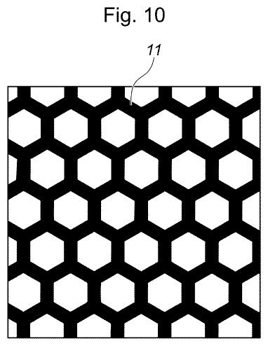

As shown in FIG. 7, FIG. 8, FIG. 9 and FIG. 10, the unit patterns of the mesh of such a nanomesh 11 or electrode mesh may, for example, be squares, rectangles, triangles, diamonds, hexagons or any other shapes and combinations thereof.

Homogeneous planar layer means a layer of substantially flat material, without significant unevenness in level, the composition and structure of which are substantially the same at all points, and which extends as a surface capable of forming an electrode with the desired surface area, for example, substantially equal to the surface of the support layer 2 where it is desired to form a luminescent film.

The first electrode layer 3 has, for example, a thickness comprised between 1 and 500 μm, preferably comprised between 10 and 50 μm, and more preferably substantially equal to 25 μm. It is deposited on the support layer 2 for example by bar coating, by vapor phase polymerization (VPP), by chemical vapor deposition (CVD), by sputtering or by dry deposition.

The first electrode layer 3, when it is provided in the form of a nanomesh 11 or an electrode mesh, preferably comprises silver nanowires (AgNWs, which stands for Ag nanowires) and/or copper nanowires (CuNWs, which stands for Cu nanowires).

Note that wide band-gap nanowires composed of gallium nitride (GaN) or zinc oxide (ZnO) are materials which may also be used for the nanowires.

When provided in the form of a planar layer, the first electrode layer 3 preferably comprises nanotubes of carbon, graphene, a material based on metal oxide, a material based on PEDOT [poly(3,4-ethylenedioxythiophene)], a material based on PEDOT:PSS [poly(3,4-ethylenedioxythiophene) mixed with sodium polystyrene sulfonate] or a material based on PEDOT:TOS [poly(3,4-ethylenedioxythiophene) mixed with tosylate]. Such a planar layer is as homogeneous as possible and usually unstructured.

The materials based on metal oxide for the first electrode layer 3 preferably comprise ITO (indium tin oxide), ZnO (zinc oxide), ZnO:Al (zinc oxide doped with aluminum), TiO2 (titanium dioxide) and SnO2:F (FTO, which stands for fluorine-doped tin oxide).

As shown in [Table 1], these various electrode compositions are transparent, and are of course excellent conductors of electricity.

TABLE 1

| | Average transmittance |
|---|---|
| Composition | in the visible spectrum |
| AgNWs | 88% |
| carbon nanotubes | 92% |
| graphene | 92% |
| ITO | 89% |
| ZnO | 80% |
| ZnO:Al | 90% |
| TiO₂ | 91% |
| FTO | 93% |
| PEDOT | 80% |
| PEDOT:PSS | 80% |
| PEDOT:TOS | 80% |

[Table 2] below gives the preferred deposition method for various examples of compositions of the first electrode layer 3.

TABLE 2

| Composition | Preferred deposition method |
|---|---|
| AgNWs | Bar coating |
| PEDOT | VPP |
| PEDOT:PSS | VPP |
| PEDOT:TOS | VPP |
| Carbon nanotubes | Dry deposition |
| Graphene | CVD |
| Metal oxide | Sputtering |
| GaN nanowires | Hydrothermal synthesis |
| ZnO nanowires | Hydrothermal synthesis |

Like the support layer 2, the first electrode layer 3 may be transparent or opaque.

The film 1 according to the invention comprises a third layer, deposited on the first electrode layer 3, namely a flexible first electrically insulating layer 4 made of dielectric material.

An electrically insulating layer 4 usually has the function of adding a low dielectric constant insulating layer between the first electrode layer 3 and the electroluminescent layer 5 in order to achieve a voltage drop in the high supply voltage (generally from 150 to 200 V) required to make the film 1 work. The electrically insulating layer 4 is provided to eliminate avalanche breakdown in the phosphor layer 6. However, it also leads to a reduction in the voltage applied in the phosphor layer 6, which reduces the brightness of the film 1. Thus, it is preferred to have an electrically insulating layer 4 with a high electric constant associated with a film 1 having a low supply voltage.

The electrically insulating layer 4 for example has a thickness comprised between 1 and 50 μm. It preferably has a thickness comprised between 5 and 30 μm, more preferably comprised between 8 and 15 μm, for example substantially equal to 10 μm.

The dielectric material of the electrically insulating layer 4 preferably comprises an epoxy resin matrix filled with alkaline-earth metal titanate particles, which alkaline-earth metal is selected from calcium titanate (CaTiO₃), barium titanate (BaTiO₃), strontium titanate (SrTiO₃), mixed perovskites of barium strontium titanate type (BaₓSr₍₁₋ₓ₎TiO₃, with 0≤x≤1) and a mixture of these products. Preferably, x is such that 0≤x<1.

Barium titanate is preferred as it has a high electric constant.

The resin used must have good compatibility with the selected alkaline-earth metal titanate particles and the phosphors. As binder between the particles, the resin must also have good conductivity. The resin must also have a good capacity for solvent release during high temperature curing to ensure complete drying at relatively low temperatures. Lastly, the resin must have good adhesion with respect to the support layer 2 used.

The resin used is preferably a phenoxy resin sold by Inchem under the name PKHH, which has good solubility in the solvent used, namely dibasic ester (DBE).

The electrically insulating layer 4 is preferably deposited by a bar coating process.

Like the support layer 2 and the first electrode layer 3, the electrically insulating layer 4 may be transparent or opaque.

The film 1 according to the invention comprises a fourth layer, deposited on the electrically insulating layer 4, namely a flexible electroluminescent layer 5.

The electroluminescent layer 5 comprises both a phosphor material capable of generating light, and a refractive index adaptation material capable of directing the light emitted by the phosphor material to the next upper layers, namely the second electrode layer 8 and the protective layer 9.

Phosphor material in this case means a material comprising electroluminescent pigments emitting white or colored light after having received energy supplied by an electric field.

In one embodiment, the electroluminescent layer 5 preferably comprises both a phosphor material capable of generating red light, and a refractive index adaptation material capable of directing the light emitted by the phosphor material to the next upper layers, namely the second electrode layer 8 and the protective layer 9.

Phosphor in this case means a material comprising electroluminescent pigments emitting light, in this case red light, after having received energy supplied by an electric field.

Thus, the electroluminescent layer 5 comprises a phosphor layer 6 having a refractive index nₗᵤₘ and at least one refractive index adaptation element 7 having a refractive index n_{ng} such that nₗᵤₘ>n_{ng}>n_{élec} where n_{élec} is the refractive index of the second electrode layer 8. Since light moves preferentially into the neighboring material having the closest lower refractive index, the light emitted by the phosphor layer 6 passes primarily through the material of the refractive index adaptation element 7, then passes through the second electrode layer 8 so as to be emitted toward the top of the film 1. Thus, since the refractive index of the refractive index adaptation element 7 is intermediate between that of the adjacent layers for which it serves as an interface, its presence reduces the refraction and/or reflection effects of the light coming from the phosphor layer 6 in the direction of the second electrode layer 8.

Laboratory tests have shown that the addition of the refractive index adaptation element 7 in a conventional electroluminescent film makes the latter between 1.8 and 2 times brighter. Thus, for a film 1 according to the invention, for which the luminance is optimized, a luminance of greater than 1600 cd/m², possibly even greater than 2000 cd/m² is obtained, values which have never been attained to date for an electroluminescent film.

According to a first variant of the invention shown in FIG. 1 and FIG. 3, the electroluminescent layer 5 comprises two successive layers, namely a phosphor layer 6 located on the electrically insulating layer 4, and a refractive index adaptation element layer 7 located on the phosphor layer 6.

According to a second variant of the invention shown in FIG. 2 and FIG. 4, the electroluminescent layer 5 comprises a heterogeneous layer comprising refractive index adaptation elements 7 located on the electrically insulating layer 4 and embedded in a phosphor layer 6. According to this second variant of the invention, a refractive index adaptation element layer 7 may also be located on said heterogeneous layer.

The phosphor layer 6 has a refractive index nim with a value of, for example, approximately equal to 4. In the context of the invention, each refractive index is measured by method A of the standard NF EN ISO 489 dated March 2022.

The phosphor layer 6 comprises zinc sulfide doped with at least one metal including copper.

“Metal composition doped with a material” in this case means a metal composition incorporating small quantities (generally of the order of ppm) of a material which is introduced into its matrix in order to modify its properties.

For example, the phosphor layer 6 comprises zinc sulfide, a mixture of zinc sulfide and cadmium sulfide, or a mixture of zinc sulfide, cadmium sulfide, zinc selenide and cadmium selenide. Preferably, either these metal compositions are doped with copper alone or they are doped with copper and with at least one compound selected from the group consisting of yttrium aluminum garnet, manganese, aluminum, europium and inorganic dyes.

Various examples of compositions for electroluminescent pigments, with the color they emit, are given in [Table 3] below. In this table, yttrium aluminum garnet (YAG) is a crystalline solid of formula Y3Al2(AlO4)3.

TABLE 3

| Color | Composition |
|---|---|
| White tinted with blue | ZnS:Cu,YAG |
| White tinted with yellow | ZnS:Cu,Mn |
| White tinted with orange | ZnS:Cu,dye |
| Dark blue | ZnS:Cu,Al |
| Light blue | ZnS:Cu,dye |
| Blue-green | ZnS:Cu |
| Green | ZnS:Cu |
| Yellow-green | (Zn,Cd)S:Cu,Eu |
| Yellow | (Zn,Cd)S:Cu,Eu |
| White tinted with orange | ZnS:Cu,Mn |
| Orange-red | ZnS:Cu,Mn |
| Red | (Zn,Cd)(S,Se):Cu |
| Orange | ZnS:Mn,Cu |

The mixture of particles in the phosphor layer 6 preferably has the following composition:

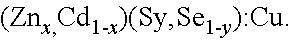

Preferably, the values of x and y are selected such that 0<x<1 and 0<y<1, more preferably such that 0.8<x<1 and 0<y<0.2 and even more preferably such that x=0.9 and y=0.1.

In order to meet current standards, the phosphor layer 6 emits a red color having a wavelength comprised between 625 and 635 nm, preferably substantially equal to 630 nm, and with a full width at half maximum of less than 20 nm.

The phosphor layer 6 has, for example, a thickness comprised between 1 and 50 μm, preferably comprised between 25 and 35 μm, and more preferably equal to 29 μm.

The phosphor layer 6 is preferably deposited by screen printing, by atomic layer deposition (ALD) or by a sol-gel process.

Deposition by screen printing or by ALD is preferred in the case of the first variant of the invention, wherein the electroluminescent layer 5 comprises two successive layers, whereas sol-gel deposition is preferred in the case of the second variant of the invention, wherein the electroluminescent layer 5 comprises refractive index adaptation elements 7 embedded in a phosphor layer 6.

Deposition by screen printing generally makes it possible to provide a phosphor layer 6 having, for example, a thickness comprised between 25 and 30 μm since the particles of the phosphor layer 6 usually have a diameter of less than or equal to 29 μm.

In the case where the phosphor layer 6 is deposited by screen printing, the electroluminescent pigments are preferably bonded in an epoxy resin matrix.

The ALD technique consists in successively exposing a surface to different chemical precursors in order to obtain ultra-thin layers. In particular, it makes it possible to deposit a phosphor layer 6 with a thickness of less than 1 μm, which considerably improves the luminous intensity of the film. To be specific, if the distance separating the electrodes is small, the electric field generated may be confined in a smaller space and the light emitted by electroluminescence is therefore stronger.

In the case where the phosphor layer 6 is deposited by ALD, the phosphor layer 6 does not comprise a matrix and is composed solely of electroluminescent pigments.

For example, the sol-gel process is combined with dip coating, which involves dipping the substrate in a suitable coating composition, then removing it and partially drip-drying it. Once the excess coating has run off, the substrate is then dried fully, for example by baking, although many other techniques exist. This process is advantageous in that it guarantees a particularly smooth surface finish with reduced roughness.

Note that the deposition technique for the phosphor layer 6 varies according to the nature of the refractive index adaptation elements 7 and their shape (for example layers or islands/lines, see below). To be specific, if the refractive index adaptation element 7 comprises nanoantennas in the form of colloidal nanoparticles, the phosphor layer 6 is preferably deposited without dipping and is composed solely of electroluminescent pigments, whereas if the refractive index adaptation element 7 comprises nanoantennas in the form of nanowires or the like, the phosphor layer 6 is preferably deposited by a sol-gel process, for example combined with dip coating. In the latter case, the dip coating process is used to deposit phosphor pigments around the nanowires in order to guarantee a particularly smooth surface finish with reduced roughness.

The refractive index adaptation element 7 is transparent and, when it is in the form of a layer, this layer is flexible.

The function of the refractive index adaptation element 7 is to direct the light emitted from the phosphor layer 6 to the second electrode layer 8 located above it, such that a greater part of the light emitted by the phosphor layer 6 passes through the second electrode layer 8, making the film 1 brighter.

Thus, the refractive index adaptation element 7 has a refractive index n_{ng}, the value of which is selected such that it is comprised between that of the two adjacent layers, namely the phosphor layer 6 and the second electrode layer 8, so as to form an intermediate layer that reduces the effects of refraction and/or reflection of the light. The refractive index n_{ng} of the refractive index adaptation element is, for example, comprised between 2 and 3.5.

The refractive index adaptation element 7 preferably comprises nanoantennas 10, also known as nano-light sensors.

These nanoantennas 10 preferably comprise nano-objects, preferably metal nano-objects, which promote the movement of the light from the phosphor layer 6 to the second electrode layer 8, on a sub-wavelength scale, so that the refractive index adaptation element 7 is also very thin and transparent.

According to a variant of the invention, the nano-objects may be colloidal nanoparticles, preferably nanocubes. They may also be three-dimensional elements with a round, oval, triangular, square, rectangular, diamond, polygonal, etc. section or other polygonal three-dimensional elements, such as tetrahedra, octahedra, dodecahedra, icosahedra, etc.

A nanoparticle is a nano-object the three dimensions of which are on a nanometric scale, i.e. a particle having a nominal diameter of less than around 100 nm.

Colloidal nanoparticles are preferably based on silver, gold, platinum or a mixture thereof.

They are, for example, silver nanocubes, sold under the brand name Nanocomposix NanoXact, in the form of a solution at 2.6×10¹¹ nanocubes/mL, with a nanocube size substantially equal to 75±7 nm.

In the case of the second variant of the invention, wherein the electroluminescent layer 5 comprises refractive index adaptation elements 7 embedded in a phosphor layer 6, the nanoparticles are preferably deposited on the electrically insulating layer 4 by drop casting, for example randomly, but in such a way that the nanoparticles are well dispersed, with no clumps, and with a density that is as homogeneous as possible on the phosphor layer 6.

In the case of the first variant of the invention, wherein the electroluminescent layer 5 comprises two successive layers, the colloidal nanoparticles are preferably embedded in a matrix, for example made of polyvinylpyrrolidone (PVP), or covered with a layer of PVP. This matrix or this layer of PVP has, for example, a thickness of around 1 to 10 nm, preferably around 3 nm.

According to another variant of the invention, the nano-objects may be nanofibers, nanotubes, nanofilaments, nanowires, nanorods, or a mixture of these nano-objects.

Nanofibers, nanotubes, nanofilaments and nanorods are nano-objects having two similar external dimensions on a nanometric scale, of less than around 100 nm, and a third dimension that is significantly greater.

These nano-objects are preferably based on zinc oxide. For example, they are grown by hydrothermal synthesis from a layer of ZnO seeds deposited directly on the phosphor layer 6 (first variant of the invention) or on the electrically insulating layer 4 (second variant of the invention).

These nano-objects are preferably arranged in the form of a very dense network of nanowires (NWS), nanofibers, nanotubes, nanofilaments and/or nanorods aligned vertically. They preferably have a diameter comprised between 30 and 50 nm and a length comprised between 400 and 500 nm.

In the case of the second variant of the invention, wherein the electroluminescent layer 5 comprises refractive index adaptation elements 7 embedded in a phosphor layer 6, the nanoparticles and nano-objects may for example be deposited in the form of islands, that is to say in the form of small groups of nanoparticles and nano-objects isolated from one another, or in the form of lines, notably parallel and/or intersecting to form a network.

The refractive index adaptation elements 7, whether embedded in the phosphor layer 6 or in the form of a separate layer, may have a very small height (or thickness in the case of a layer), in particular less than 1 μm.

Like the support layer 2, the first electrode layer 3 and the first electrically insulating layer 4, the electroluminescent layer 5 may be transparent, translucent or opaque, in particular depending on its thickness and composition.

The film 1 according to the invention comprises a fifth layer, deposited on the electroluminescent layer 5, namely a second flexible and transparent electrode layer 8 made of conductive material.

This second electrode layer 8 may have the same characteristics as the first electrode layer 3.

It has a refractive index n_{élec} with a value of, for example, approximately equal to 1.5.

Within the same film 1 according to the invention, the first electrode layer 3 and the second electrode layer 8 may be identical, for example in terms of their nature, their composition, their thickness and/or their deposition process, but they may also be different. However, it is more practical and less expensive for the manufacture of the film 1 for the first electrode layer and the second electrode layer 3, 8 to be identical.

The first electrode layer and the second electrode layer 3, 8 are provided to be connected to an alternating current source in order to form an electrostatic field between them, capable of exciting the phosphor layer 6 provided between these two layers 3, 8.

Lastly, the film 1 according to the invention comprises a sixth layer, preferably an upper layer, deposited on the second electrode layer 8, namely a flexible and transparent protective layer 9.

This protective layer 9 has, for example, a thickness comprised between 0.5 and 2.0 mm, preferably comprised between 0.8 and 1.5 mm and more preferably equal to 1.1 mm.

It is preferably deposited by printing.

The protective layer 9 is preferably made of PET (polyethylene terephthalate), Plasil (siloxane based on polymerized silicon monoxide), PMMA (polymethyl methacrylate), PCL (polycaprolactone), PC (polycarbonate), COP (cyclic olefin polymer) or a mixture of at least two of these products.

The protective layer 9 preferably comprises a transparent anti-UV material, an anti-UV additive or a transparent anti-UV coating in order to protect the film 1 from the harmful effects of ultraviolet radiation.

To be specific, the UV protection may be embedded in the mass of the material constituting the protective layer 9, or may be in the form of a coating deposited on the lower and/or upper layer of said protective layer 9.

Likewise, the constituent material of the protective layer 9 may naturally have an anti-UV effect, or may be modified so as to have such an effect without this significantly negatively affecting its flexibility and transparency.

Thus, the protective layer 9 comprises, for example, a layer of transparent anti-UV material selected from an acrylic resin, a mixture of high-density polyethylene and zinc oxide, polycarbonate, polyamide-imide and poly(vinylidene fluoride).

The following materials are known to have anti-UV action: anti-UV Plasil, PC, PCL, PMMA, PET and COP.

Six examples of films 1 according to the invention are given in [Table 4], while [Table 5] states the characteristics of overall thickness, flexibility, bending strength and luminance for these various examples.

TABLE 4

| | Film No 1 | Film No 2 | Film No 3 | Film No 4 | Film No 5 | Film No 6 |
|---|---|---|---|---|---|---|
| Support layer | PET, | PET, | PET, | PET, | PET, | PET, |
| | thickness 1.1 mm | thickness 1.1 mm | thickness 0.5 mm | thickness 0.5 mm | thickness 1.1 mm | thickness 1.1 mm |
| First | ITO nanomesh, | ITO nanomesh, | Silver nanowires, | Silver nanowires, | PET, | ITO nanomesh, |
| electrode layer | thickness >2 μm | thickness >2 μm | thickness 25 μm | thickness 25 μm | thickness 1.1 mm | thickness >2 μm |
| Electrically | BaTiO₃ + | BaTiO₃ + | BaTiO₃ + | BaTiO₃ + | BaTiO₃, | BaTiO₃, |
| insulating layer | epoxy resin, | epoxy resin, | epoxy resin, | epoxy resin, | ALD | ALD |
| | thickness 10 μm | thickness 10 μm | thickness 10 μm | thickness 10 μm | thickness >1 μm | thickness >1 μm |
| Phosphor | ZnS:Cu blue-green | ZnS:Cu blue-green | ZnS:Cu | ZnS:Cu | ZnS:Cu | ZnS:Cu |
| | thickness ~25 μm | and | blue-green | blue-green | blue-green | blue-green |
| | | (Zn, Cd)(S, Se):Cu Red | thickness ~25 μm | and | ALD | and |
| | | thickness ~25 μm | | (Zn, Cd)(S, Se):Cu | thickness >1 μm | (Zn, Cd)(S, Se):Cu |
| | | | | red | | red |
| | | | | thickness ~25 μm | | ALD |
| | | | | | | thickness >1 μm |
| Refractive index | Network of very | Network of very | Ag nanocubes | Ag nanocubes | Network of very | Ag nanocubes |
| adaptation element | dense and | dense and | NanoXact 75 | NanoXact 75 | dense and | NanoXact 75 |
| | vertically | vertically | surrounded by a 3 | surrounded by a 3 | vertically | surrounded by a 3 |
| | aligned ZnO | aligned ZnO | nm PVP layer | nm PVP layer | aligned ZnO | nm PVP layer |
| | nanowires | nanowires | | | nanowires | |
| Second electrode | Silver nanowires, | Silver nanowires, | Silver nanowires, | Silver nanowires, | ITO nanomesh, | ITO nanomesh, |
| layer | thickness 25 μm | thickness 25 μm | thickness 25 μm | thickness 25 μm | thickness >2 μm | thickness >2 μm |
| Protective layer | Plasil, | Plasil, | Plasil, | Plasil, | Plasil, | Plasil, |
| | thickness 0.5 mm | thickness 0.5 mm | thickness 1.1 mm | thickness 1.1 mm | thickness 0.5 mm | thickness 0.5 mm |

It can be seen from [Table 4] that the support layer 2 and the protective layer 9 determine practically by themselves the overall thickness of the film 1. If account is taken only of the electrically insulating layer 4 and the electroluminescent layer 5, which can be denoted functional layers, a total thickness of around 35 μm is obtained, which is extremely thin.

TABLE 5

| | Film No 1 | Film No 2 | Film No 3 | Film No 4 | Film No 5 | Film No 6 |
|---|---|---|---|---|---|---|
| Overall | ~1.7 mm | ~1.7 mm | ~1.7 mm | ~1.7 mm | ~1.6 mm | ~1.6 mm |
| thickness | | | | | | |
| Flexibility | 6.5% | 6.5% | 6.5% | 6.5% | 6.5% | 6.5% |
| | minimum for | minimum for | minimum for | minimum for | minimum for | minimum for |
| | an area of | an area of | an area of | an area of | an area of | an area of |
| | 150 cm² | 150 cm² | 150 cm² | 150 cm² | 150 cm² | 150 cm² |
| Bending | luminance | luminance | luminance | luminance | luminance | luminance |
| strength | >88% after | >88% after | >88% after | >88% after | >88% after | >88% after |
| | 1000 | 1000 | 1000 | 1000 | 1000 | 1000 |
| | bending | bending | bending | bending | bending | bending |
| | cycles | cycles | cycles | cycles | cycles | cycles |
| Luminance | >1000 | >1000 | >1000 | >1000 | >1000 | >1000 |
| | cd/m² with a | cd/m² with a | cd/m² with a | cd/m² with a | cd/m² with a | cd/m² with a |
| | power | power | power | power | power | power |
| | supply | supply | supply | supply | supply | supply |
| | of ~195 V | of ~195 V | of ~195 V | of ~195 V | of <195 V | of <195 V |
| | at 2 kHz | at 2 kHz | at 2 kHz | at 2 kHz | at 2 kHz | at 2 kHz |

The bending strength of the films was measured using the method described in the article entitled “Highly flexible transparent electrodes based on mesh-patterned rigid indium tin oxide” from the journal Nature, published online on Feb. 12, 2018.

The luminance of the films was measured using a broadband calibrated optical luminance meter (TES-137, TES Electric Electronic Co.).

It is clear from [Table 5] that the electroluminescent film 1 according to the invention has highly satisfactory mechanical properties and a luminance very much greater than found in prior art electroluminescent films.

The invention also relates to a method for manufacturing a film 1 as described above, and comprising the following successive steps:
providing a flexible support layer 2;
depositing a first flexible electrode layer 3 made of conductive material on the flexible support layer 2;
depositing a flexible electrically insulating layer 4 made of dielectric material on the first electrode layer 3;
depositing a flexible electroluminescent layer 5, comprising a phosphor layer 6 having a refractive index nₗᵤₘ and at least one refractive index adaptation element 7 having a refractive index n_{ng};
depositing a second flexible and transparent electrode layer 8 made of conductive material on the electroluminescent layer 5, said second electrode layer 8 having a refractive index n_{élec};
depositing a flexible and transparent protective layer 9 on the second electrode layer 8;
where nₗᵤₘ>n_{ng}>n_{élec}.

What is claimed is:

1. A flexible electroluminescent film, comprising:
a flexible support layer;
a first flexible electrode layer made of conductive material;
a flexible electrically insulating layer made of dielectric material;
a flexible electroluminescent layer, including a phosphor layer having a refractive index nₗᵤₘ and at least one refractive index adaptation element having a refractive index n_{ng};
a second flexible and transparent electrode layer made of conductive material having a refractive index n_{élec};
a flexible and transparent protective layer;
in which nₗᵤₘ>n_{ng}>n_{élec}.

2. The film as claimed in claim 1, wherein the phosphor layer includes zinc sulfide doped with at least one metal including copper.

3. The film as claimed in claim 1, wherein the electroluminescent layer includes a refractive index adaptation element layer located above the phosphor layer.

4. The film as claimed in claim 1, wherein the electroluminescent layer includes refractive index adaptation elements embedded in the phosphor layer.

5. The film as claimed in claim 1, wherein the at least one refractive index adaptation element includes nanoantennas.

6. The film as claimed in claim 5, wherein the nanoantennas are colloidal nanoparticles.

7. (canceled)

8. (canceled)

9. The film as claimed in claim 1, wherein the dielectric material of the electrically insulating layer includes an epoxy resin matrix filled with alkaline-earth metal titanate particles selected from: CaTiO₃, BaₓSr₍₁₋ₓ₎TiO₃ and a mixture thereof, with 0≤x≤1.

10. The film as claimed in claim 1, wherein at least one layer out of the first electrode layer and the second electrode layer is in the form of a nanomesh, an electrode mesh or a homogeneous planar layer.

11. The film as claimed in claim 1, wherein at least one layer out of the first electrode layer and the second electrode layer includes nanowires of silver, copper, gallium nitride or zinc oxide, nanotubes of carbon, graphene, a material based on metal oxide, a material based on poly(3,4-ethylenedioxythiophene), a material based on poly(3,4-ethylenedioxythiophene) mixed with sodium polystyrene sulfonate or a material based on poly(3,4-ethylenedioxythiophene) mixed with tosylate.

12. The film as claimed in claim 11, wherein the material based on metal oxide includes at least one compound selected from indium-tin oxide, zinc oxide, aluminum-doped zinc oxide, titanium dioxide and fluorine-doped tin dioxide.

13. The film as claimed in claim 1, wherein the support layer, the first electrode layer, the electrically insulating layer and the electroluminescent layer are transparent.

14. The film as claimed in claim 1, wherein at least one layer out of the support layer and the protective layer is made of polyethylene terephthalate, a siloxane based on polymerized silicon monoxide, polymethyl methacrylate, polycaprolactone, polycarbonate or a mixture of two or more of these products.

15. The film as claimed in claim 1, wherein the phosphor layer includes zinc sulfide, a mixture of zinc sulfide and cadmium sulfide, or a mixture of zinc sulfide, cadmium sulfide, zinc selenide and cadmium selenide, these metal compositions being doped with copper alone or doped with copper and with at least one compound selected from the group consisting of yttrium aluminum garnet, manganese, aluminum, europium and inorganic dyes.

16. The film as claimed in claim 1, wherein the protective layer includes a transparent anti-UV material, an anti-UV additive or a transparent anti-UV coating.

17. The film as claimed in claim 1, wherein the protective layer includes a layer of transparent anti-UV material selected from an acrylic resin, a mixture of high-density polyethylene and zinc oxide, polycarbonate, polyamide-imide and poly(vinylidene fluoride).

18. The film as claimed in claim 1, wherein the film has an overall thickness between 1.0 and 5.0 mm.

19. A film comprising:
a support layer made of PET;
a first electrode layer including an indium tin oxide nanomesh, silver nanowires or copper nanowires;
an electrically insulating layer including an epoxy resin matrix filled with barium titanate particles;
an electroluminescent layer, including a phosphor layer including zinc sulfide doped with at least one metal including copper, and including at least one refractive index adaptation element including zinc oxide nanowires or silver nanocubes;
a second electrode layer including an indium tin oxide nanomesh, silver nanowires or copper nanowires; and
a protective layer including Plasil.

20. The film as claimed in claim 1, wherein the phosphor layer emits red light when excited by an electrostatic field.

21. The film as claimed in claim 20, wherein the phosphor layer includes a mixture of particles of zinc sulfide, cadmium sulfide, zinc selenide and cadmium selenide, which particles are doped with copper.

22. The film as claimed in claim 21, wherein the mixture has the following composition: (Znₓ,Cd₁₋ₓ)(S_{y},Se_{1-y}):Cu, with 0<x<1 and 0<y<1.

23. (canceled)

24. (canceled)
